(19) United States
(12) Patent Application Publication
(10) Pub. No.: US 2014/0344094 A1
(43) Pub. Date: Nov. 20, 2014

(54) INFORMATION PROCESSING APPARATUS, INFORMATION PROCESSING METHOD, AND INFORMATION PROCESSING PROGRAM

(71) Applicant: RAKUTEN, INC., Shinagawa-ku, Tokyo (JP)

(72) Inventor: Sadaaki Emura, Shinagawa-ku (JP)

(73) Assignee: RAKUTEN, INC., Shinagawa-ku, Tokyo (JP)

(21) Appl. No.: 14/360,837

(22) PCT Filed: May 31, 2013
(86) PCT No.: PCT/JP2013/065255

§ 371 Date: May 27, 2014

(30) Foreign Application Priority Data
Sep. 28, 2012 (JP) 2012-218662

(51) Int. Cl. G06Q 30/08

(52) U.S. Cl. CPC G06Q 30/08
USPC 705/26.3

(57) ABSTRACT

Apparatus, method, program, and recording medium for notifying the probability of bids by other user to a user before the other user makes a bid. An information processing server specifies an alert notification target auction where a prompt decision price has been set, specifies a bid price monitoring target auction where at least one of an item name and an item code of an item exhibited in the alert notification target auction is matched, and notifies an alert to at least one of a bidder who makes a bid at the alert notification target auction where the prompt decision price has been set, and a certain potential bidder who probably makes a bid at the auction, when the highest bid price in the bid price monitoring target auction satisfies the predetermined condition for the reference price according to the prompt decision price set to the alert notification target auction.

### TECHNICAL FIELD

The present invention relates to a technical field of systems and methods which notify information on bids at auction to a user of auction.

### BACKGROUND ART

In the past, there have been known system in which when there is a bid from other user B at the highest bid price exceeding a bid price set by a user A in an auction performed via a network (online auction), that effect is notified to the user A. For example, Patent Literature 1 discloses an auction system that transmits an excess bid notification email to a user's mobile terminal when the highest bid price is updated by another bidder after the user makes a bid.

### PRIOR ART LIST

### Patent Literature

Patent Literature 1: JP 2002-083170 A

### SUMMARY OF THE INVENTION

### Problem to be Solved by the Invention

However, in the conventional technique, including Patent Literature 1, for example, the notification to the user A is not performed before other user B makes a bid at the highest bid price exceeding the bid price set by the user A at the auction. Therefore, in a case where a prompt decision price (prompt contract price) is set by an exhibitor in the auction where the user A set the bid price, if the user B makes a bid at the same price as the prompt decision price, the user A cannot cope with the bid of the user B because that the auction has already been finished even though that effect is transmitted to the user A.

The present invention has been made in consideration of the above points and is directed to provide an information processing apparatus, an information processing method, and an information processing program, which can notify the probability of bids by other user to a user of auction before the other user makes a bid.

### Means for Solving the Problem

In order to solve the above problem, the invention according to claim 1 is an information processing apparatus comprising:

a first specifying means that specifies an auction in which a prompt decision price has been set and which has been unfinished, from a storing means that stores information on an auction of an exhibited item with respect to each of a plurality of auctions;

a second specifying means that specifies other auction in which at least one of an item name and an item code of the item exhibited in the auction is matched and which has been unfinished, from the storing means, the item name and the item code being included in the information on the auction specified by the first specifying means; and

a notifying means that, when a highest bid price in the other auction specified by the second specifying means satisfies a predetermined condition for a reference price according to the prompt decision price set to the auction specified by the first specifying means, notifies an alert to at least one of a bidder who makes a bid at the auction where the prompt decision price is set and a certain potential bidder who probably makes a bid at the auction.

According to the present invention, before other user makes a bid, the probability of bids by the other user can be notified to a user of an auction where the prompt decision price has been set.

The invention according to claim 2 is the information processing apparatus according to claim 1, further comprising:

a setting means that sets the reference price according to a bid unit based on the prompt decision price as a reference.

According to the present invention, since the unit of the reference price can be matched with the unit by which the highest bid price is increased, the calculation process can be performed more quickly.

The invention according to claim 3 is the information processing apparatus according to claim 1 or 2, further comprising:

a first determining means that, when there are a plurality of auctions where the highest bid price in the other auction satisfies the predetermined condition for the reference price, determines a priority of the alert notification with respect to auctions of at least a part of the plurality of auctions, based on a magnitude relationship of the prompt decision price set to the auction,

wherein the notifying means notifies an alert to the user of the auction in which the prompt decision price is set, according to the priority of the alert notification set by the first determining means.

According to the present invention, the alert can be preferentially notified to the user of the auction of which the urgency of the alert notification is higher, while reducing a load applied on the network or the like.

The invention according to claim 4 is the information processing apparatus according to claim 1 or 2, further comprising:

an acquiring means that, when there are a plurality of auctions where the highest bid price in the other auction satisfies the predetermined condition for the reference price, acquires time zone information indicating usage time zone based on auction usage result by a bidder who makes a bid at each of the auctions; and

a first determining means that determines a priority of the alert notification with respect to at least a part of the plurality of auctions, based on usage time zone indicated by the time zone information acquired by the acquiring means, and a current time, and

wherein the notifying means notifies an alert to the user of the auction where the prompt decision price has been set, according to the priority of the alert notification determined by the first determining means.

According to the present invention, the alert can be preferentially notified to the user who can quickly respond to the alert notification, while reducing a load applied on the network or the like.

The invention according to claim 5 is the information processing apparatus according to claim 1 or 2, further comprising:

a first determining means that, when there are a plurality of auctions where the highest bid price in the other auction satisfies the predetermined condition for the reference price, determines a priority of the alert notification with respect to the auctions browsed or registered in a watch list after the bid of the other auction by a bidder who makes a bid at the other auction,

wherein the notifying means notifies an alert to the user of the auction where the prompt decision price has been set, according to the priority of the alert notification determined by the first determining means.

According to the present invention, the alert can be preferentially notified to the user of the auction of which the urgency of the alert notification is higher, while reducing a load applied on the network or the like.

The invention according to claim 6 is the information processing apparatus according to claim 1 or 2, further comprising:

an acquiring means that, when there are a plurality of auctions where the highest bid price in the other auction satisfies the predetermined condition for the reference price, acquires browsing time information indicating browsing time when at least one page among pages capable of browsing situations of the respective auctions was browsed after the bid of the other auction by a bidder who makes a bid at the other auction; and

a first determining means that determines a priority of the alert notification with respect to auctions of at least a part of the plurality of auctions, based on the browsing time indicated by the browsing time information acquired by the acquiring means,

wherein the notifying means notifies an alert to the user of the auction where the prompt decision price has been set, according to the priority of the alert notification determined by the first determining means.

According to the present invention, the alert can be preferentially notified to the user of the auction of which the urgency of the alert notification is higher, while reducing a load applied on the network or the like.

The invention according to claim 7 is the information processing apparatus according to any one of claims 3 to 6, further comprising:

a second determining means that determines a range of the auction of which the priority of the alert notification is determined, based on the number of bidders who make a bid at the other auction.

According to the present invention, the alert can be notified in consideration of the load applied on the network and the necessity of the alert notification.

The invention according to claim 8 is the information processing apparatus according to any one of claims 3 to 7,

wherein the first determining means determines the priority of the alert notification when it is determined that an item in the auction is not an item targeted for multiple purchases.

According to the present invention, whether to notify the alert without determining the priority or whether to determine the priority and notify the alert can be efficiently switched based on the attribute of the item.

The invention according to claim 9 is the information processing apparatus according to any one of claims 1 to 8,

wherein the notifying means determines whether to notify the alert, based on a past bid history or purchase history of a bidder who makes a bid at the other auction.

According to the present invention, it is possible to reduce the load applied on the network by the alert notification.

The invention according to claim 10 is the information processing apparatus according to claim 9,

wherein the notifying means determines to notify the alert when it is determined the bidder of the other auction is a user who made a bid at a past auction at a predetermined number of times or more, based on the past bid history of the bidder of the other auction.

According to the present invention, the alert is notified to the user of the auction where the prompt decision price has been set, only when it is highly probable to make a bid at the auction where the prompt decision price has been set, just like a user who has a competitive spirit to return a bid when a bid is made to other person. Therefore, the load applied to the network or the like can be reduced.

The invention according to claim 11 is the information processing apparatus according to claim 9,

wherein the notifying means determines to notify the alert when it is determined that the bidder of the other auction is a user who made a successful bid for an item at the prompt decision price in a past auction, based on the past bid history of the bidder of the other auction.

According to the present invention, the alert is notified to the user of the auction where the prompt decision price has been set, only when it is highly probable to make a bid at the auction where the prompt decision price has been set, just like a user who experienced a successful bid at a prompt decision price in the past. Therefore, the load applied to the network or the like can be reduced.

The invention according to claim 12 is the information processing apparatus according to claim 9,

wherein the notifying means determines to notify the alert when it is determined that the bidder of the other auction is a user who purchased a plurality of the same items, based on a past purchase history of the bidder of the other auction.

According to the present invention, the alert is notified to the user of the auction where the prompt decision price has been set, only when it is highly probable to make a bid at the auction where the prompt decision price has been set, just like a user who is highly probable to make a bid at a plurality of auctions where the same item is exhibited. Therefore, the load applied to the network or the like can be reduced.

The invention according to claim 13 is the information processing apparatus according to any one of claims 1 to 12, further comprising:

a third determining means that determines a range of the user to which the alert is to be notified, based on the number of the auctions specified by the first specifying means.

According to the present invention, processing load can be reduced because it is possible to prevent the priority of the alert notification from being determined beyond the need for the auction which satisfies the predetermined condition.

The invention according to claim 14 is an information processing method, which is performed by a computer,

the information processing method comprising:

a first specifying step of specifying an auction in which a prompt decision price has been set and which has been unfinished, from a storing means that stores information on an auction of an exhibited item with respect to each of a plurality of auctions;

a second specifying step of specifying other auction in which at least one of an item name and an item code of the item exhibited in the auction is matched and which has been unfinished, from the storing means, the item name and the item code being included in the information on the auction specified by the first specifying step; and

a notifying step of, when a highest bid price in the other auction specified by the second specifying step satisfies a predetermined condition for a reference price according to the prompt decision price set to the auction specified by the first specifying step, notifying an alert to at least one of a bidder who makes a bid at the auction where the prompt decision price is set and a certain potential bidder who probably makes a bid at the auction.

The invention according to claim 15 is an information processing program for causing a computer to function as:

a first specifying means that specifies an auction in which a prompt decision price has been set and which has been unfinished, from a storing means that stores information on an auction of an exhibited item with respect to each of a plurality of auctions;

a second specifying means that specifies other auction in which at least one of an item name and an item code of the item exhibited in the auction is matched and which has been unfinished, from the storing means, the item name and the item code being included in the information on the auction specified by the first specifying means; and

a notifying means that, when a highest bid price in the other auction specified by the second specifying means satisfies a predetermined condition for a reference price according to the prompt decision price set to the auction specified by the first specifying means, notifies an alert to at least one of a bidder who makes a bid at the auction where the prompt decision price is set and a certain potential bidder who probably makes a bid at the corresponding auction.

### Advantageous Effects of the Invention

According to the present invention, before other user makes a bid, the probability of bids by the other user can be notified to a user of an auction where a prompt decision price has been set.

### BRIEF DESCRIPTION OF THE DRAWINGS

FIG. 1 is a diagram illustrating an example of a schematic configuration of an auction processing system S according to the present embodiment.

FIG. 2A is a diagram illustrating an example of a schematic configuration of an information processing server SA according to the present invention, and FIG. 2B is a diagram illustrating an example of a functional block of a system control unit 4.

FIGS. 3A and 3B are diagrams illustrating an example of contents registered in various databases.

FIG. 4A is a flowchart illustrating an example of a bid reception process in the system control unit 4 of the information processing server SA, and FIG. 4B is a flowchart illustrating details of an alert notification determination process in step S3 of FIG. 4A.

FIGS. 5A to 5C are diagrams illustrating an example (part) of information registered in an auction information database 21 at the time of condition determination of each step S103.

FIG. 6 is a flowchart illustrating an example of a modification of the alert notification determination process.

FIGS. 7A and 7B are diagrams illustrating an example (part) of information registered in the auction information database 21 at the time of processing of step S206.

### MODE FOR CARRYING OUT THE INVENTION

Hereinafter, embodiments of the present invention will be described with reference to the drawings. Also, embodiments described below are embodiments in a case where the present invention is applied to an auction processing system.

### [1. Overview of Configuration and Function of Auction Processing System]

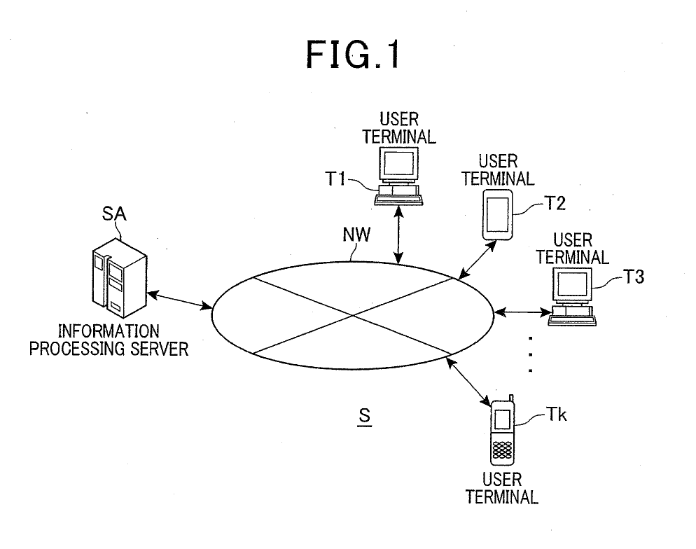

First, a schematic configuration and function of an auction processing system S according to an embodiment of the present invention will be described with reference to FIG. 1. FIG. 1 is a diagram illustrating an example of a schematic configuration of an auction processing system S according to the present embodiment. As illustrated in FIG. 1, the auction processing system S includes a plurality of user terminals Tn (n=1, 2, 3 . . . k) and an information processing server SA. Each of the user terminals Tn and the information processing server SA is connected to a network NW. The network NW is constructed by, for example, Internet, a dedicated communication line (for example, community antenna television (CATV) line), a mobile communication network (including a base station and the like), a gateway, or the like.

The information processing server SA is an information processing apparatus that performs a variety of processing related to an auction carried out through the network NW, and provides an auction site to the user terminals Tn. In response to a request from the user terminal Tn accessing an auction site, the information processing server SA transmits an auction-related page (for example, web page) to the user terminal Tn (terminal device) of the auction user and displays the auction-related page on the user terminal Tn. Examples of the auction user may include an exhibitor (auction exhibitor) who exhibits an item in an auction, a bidder (auction bidder) who bids at an auction of the exhibited item, and a registrant (watch list registrant) who registers a desired auction in its own watch list. Herein, the watch list refers to a list that can be allowed to user to easily browse a trend of an auction by registering an auction in which a user is interested. Also, a visitor (visitor of auction) who browses the trend of the auction includes an exhibitor of auction, a bidder of auction, and users other than a watch list registrant. The visitor of auction other than the exhibitor and the bidder of auction is a user who can bid at an auction from now. Of such visitors, in particular, a watch list registrant is a user who is relatively highly probable to bid at an auction.

Software, such as a web browser, is installed on the user terminal Tn that is used by the user of auction. The user terminal Tn displays the web page acquired by transmitting a request to the information processing server SA through the web browser. The user can exhibit an item in an auction, bid at an auction, or register a watch list to an auction through the web page displayed on the display. Also, as an example of the user terminal Tn, a personal computer, a personal digital assistant (PDA), a mobile information terminal such as a smartphone, a mobile phone, a portable game machine, or the like is used.

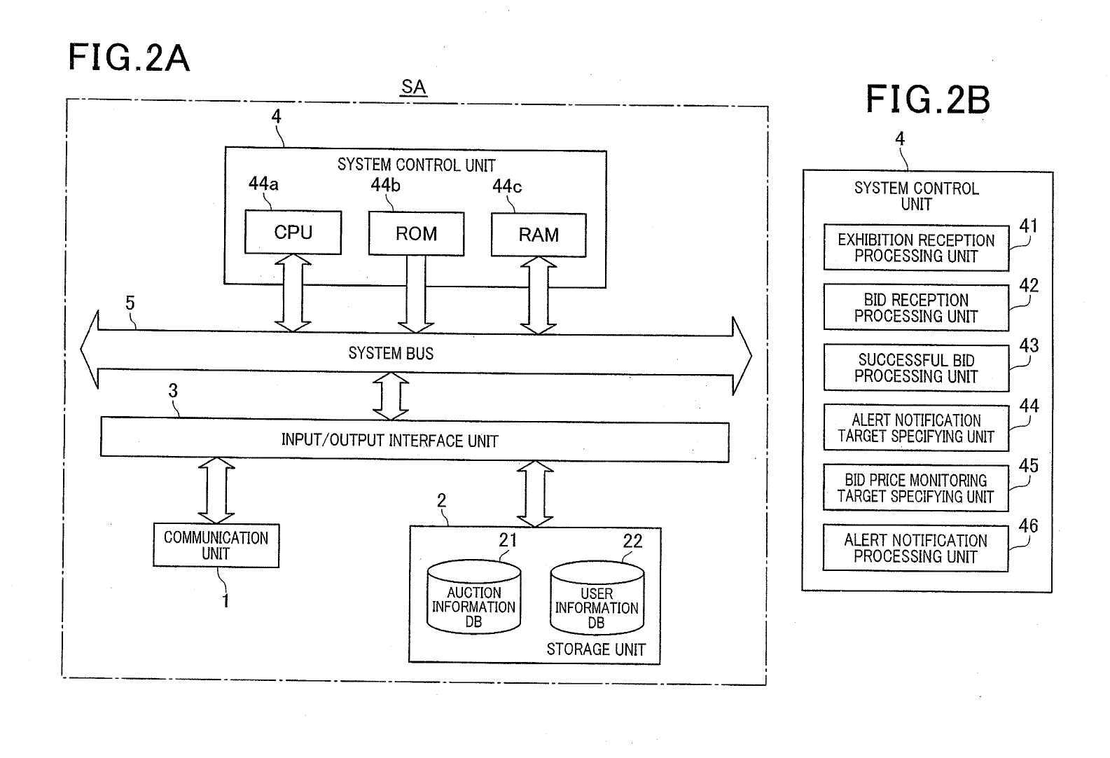

FIG. 2A is a diagram illustrating an example of a schematic configuration of the information processing server SA according to the present embodiment. As illustrated in FIG. 2A, the information processing server SA includes a communication unit 1, a storage unit 2, an input/output interface unit 3, and a system control unit 4. The system control unit 4 and the input/output interface unit 3 are connected through a system bus 5. The communication unit 1 is connected to a network NW to control states of communication with the user terminal Tn.

The storage unit 2 includes, for example, a hard disk drive or the like, and stores various programs, such as an operating system and an auction processing program (including an information processing program of the present invention). Also, the information processing program, for example, may be downloaded from a predetermined server or the like through the network NW, or may be recorded in a recording medium such as a compact disc (CD) or a digital versatile disc (DVD) and read therefrom. Also, structured document (for example, hyper text markup language (HTML) document, XHTML document, or the like) files, image data, and the like constituting a web page displayed on the user terminal Tn are stored in the storage unit 2. Furthermore, an auction information database (DB) 21 in which information on auction of exhibited items is registered for each of a plurality of auctions, a user information database (DB) 22 in which user information of users of whom the auction utilization registration has been made is registered for each user, and the like are provided in the storage unit 2. Also, the auction information database 21 and the user information database 22 are provided in a different server from the information processing server SA.

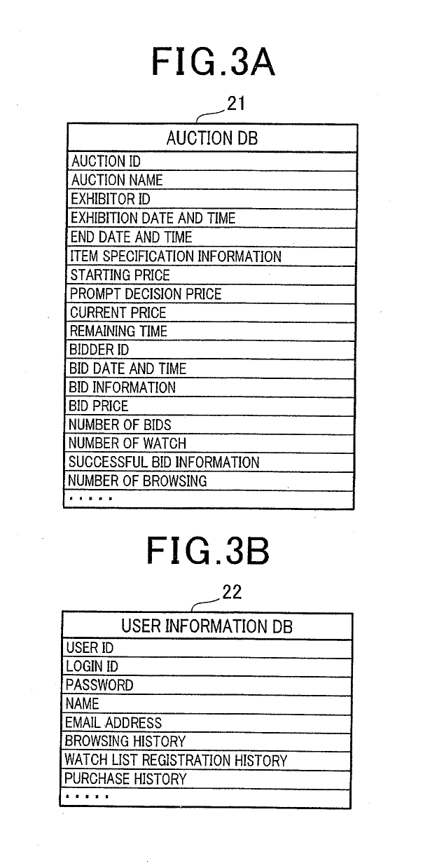

FIGS. 3A and 3B are diagrams illustrating an example of contents registered in various databases. The auction information database 21 stores an auction ID, an auction name, an exhibitor ID, an exhibition date and time, an end date and time, item specification information, a starting price, a prompt decision price (immediate bid price), a current price, a remaining time, a bidder ID, a bid date and time, a bid price, number of bids, number of watch, number of browsing, and the like in association with respect to each auction. Also, when a successful bid for an exhibited item is made, a contract price of the item and a delivery destination of a successful bidder are registered in the auction information database 21. Also, in FIG. 3A, although not illustrated, information on a delivery method, a payment method, and the like is also included in the auction information database 21. Also, detailed information on the exhibited item (information on item description and the like) may be registered in the auction information database 21 in association with the auction ID, or may be registered in an item information database (not illustrated), which is provided separately from the auction information database 21, in association with the auction ID. Furthermore, among pieces of the information registered in the auction information database 21, information being updated until an end date and time, such as a current price and a remaining time, is registered in a database (not illustrated), which is provided separately from the auction information database 21, in association with the auction ID.

Herein, the auction ID is identification information that identifies auction, and is different for each auction. The auction name is a name of an auction itself arbitrarily given by an exhibitor. For example, the auction name is constituted by a character string including an item name related to an exhibition or a feature thereof (which may include a symbol or a number). Herein, the exhibitor ID is identification information that identifies an exhibitor of auction. For example, the exhibitor ID is a user ID of the exhibitor. The exhibition date and time is a date and time when an item was exhibited in a corresponding auction by an exhibitor of auction. The end date and time is a date and time when an auction is ended. For example, the end date and time is set by being designated on a web page by an exhibitor of auction. The item specification information is information that can specify an exhibited item. For example, the item specification information is set by being designated on a web page by an exhibitor of auction. The item specification information corresponds to, for example, an item name of an item exhibited in a corresponding auction, an item code of an exhibited item, an item category of an exhibited item, an item image of an exhibited item, and the like. The item name is constituted by a character string (which may include a symbol or a number) and the like. Also, there is a case where the item name and the auction name are identical to each other. The item code corresponds to, for example, a model number of an item (set by a manufacturer of an item), a part number of an item (for example, a number described below a barcode given to an item), a JAN code, and the like. There is also a case where the item specification information may be constituted by only the item name or the item code.

The prompt decision price is a price at which a successful bid for an item can be immediately made (promptly decided) before an end time of an auction. The prompt decision price is set by being designated on a web page by an exhibitor of auction. In other words, the prompt decision price refers to a price at which a successful bid can be made on a first-come-first-served basis of bid. The starting price is a price when an auction is started. For example, the starting price is set by being designated on a web page by an exhibitor of auction. The current price is the highest bid price and is updated whenever there is a bid. Also, when no bid is present, the current price is the starting price. The remaining time is a time to an end time of an auction.

The bidder ID is identification information that identifies a bidder of auction. For example, the bidder ID is a user ID of a corresponding bidder. The bid date and time is a date and time when a bidder of auction made a bid at an auction. The bid price is a bid amount designated when a bidder of auction bids at an auction. Also, when a plurality of bidders has bid at an auction, a set of a bidder ID of each bidder, a bid date and time, and a bid price is registered in association with an auction ID of a corresponding auction. The number of bids is the number of bidders of auction. The number of watch is the number of water list registrants. The number of browsing is the number of visitors of auction.

Information such as a user ID, a login ID, a password, a name, an email address, a browsing history, a watch list registration history, a purchase history, and the like is registered in the user information database 22a illustrated in FIG. 3B in association with each user.

Herein, the user ID is identification information that identifies a user of whom the auction utilization registration has been made. The user of whom the auction utilization registration has been made can exhibit an item in an auction or bid at an auction. The login ID and the password are authentication information for logging in, for example, when a user exhibits an item in an auction or bids at an auction.

The browsing history includes, for example, a URL of a web page browsed by a user (web page on which information on an item exhibited in an auction is posted), an auction ID of an auction of an item disposed in a browsed web page, a browsing date and time, and the like. Also, the browsing history is registered when the web page is displayed in the user terminal Tn by the operation of the logged-in user or when information on the web page is transmitted to the user in response to a request from the user terminal Tn. Alternatively, the browsing history stored by the web browser of the user terminal Tn may be transmitted to the information providing server SA when the user of the user terminal Tn logs in, and be registered therein. Also, the browsing history may be configured to be registered in a browsing history database, which is provided separately from the user information database 22, in association with the user ID.

The watch list registration history includes, for example, an auction ID of an auction registered and designated in a watch list by a user, a registration date and time, and the like. Also, the watch list registration history may be configured to be registered in a watch list database, which is provided separately from the user information database 22, in association with the user ID.

The purchase history includes an item name or an item code of an item purchased by a user in an auction site or a shopping site, number of purchases, a purchase price, a purchase date and time, and the like. Also, the purchase history may be configured to be registered in a purchase history database, which is provided separately from the user information database 22, in association with the user ID.

The input/output interface unit 3 is configured to perform interface processes between the communication unit 1 and the storage unit 2, and the system control unit 4.

The system control unit 4 is configured to include a central processing unit (CPU) 4a, a read only memory (ROM) 4b, a random access memory (RAM) 4c, and the like. FIG. 2B is a diagram illustrating an example of a functional block of the system control unit 4. The system control unit 4 as a computer performs a variety of auction-related processing according to an auction processing program stored in the storage unit 2. In such processing, as illustrated in FIG. 2B, the system control unit 4 functions as an exhibition reception processing unit 41, a bid reception processing unit 42, a successful bid processing unit 43, an alert notification target specifying unit 44, a bid price monitoring target specifying unit 45, an alert notification processing unit 46, and the like. Also, the exhibition reception processing unit 41 is an example of a setting means in the present invention. The alert notification target specifying unit 44 is an example of a first specifying means in the present invention. The bid price monitoring target specifying unit 45 is an example of a second specifying means in the present invention. The alert notification processing unit 46 is an example of an acquiring means, first to third determining means, and a notifying means in the present invention.

The exhibition reception processing unit 41 performs, for example, a process of providing a web page, which allows an exhibition to an auction, to the user terminal Tn, a process of acquiring exhibition information from the user terminal Tn of the exhibitor of auction, a process of setting various parameters, a process of setting an auction ID, a process of registering the exhibition information, and the like. Herein, the exhibition information includes, for example, an exhibitor ID, an exhibition date and time, an end date and time, item specification information, a starting price, a prompt decision price, and the like. Also, the prompt decision price is included in the exhibition information only when the prompt decision price is designated by the exhibitor of auction. In the setting of the various parameters, a current price is set to a corresponding auction (the starting price is set as the current price), based on the starting price. Also, when the prompt decision price is included in the exhibition information, the prompt decision price is set to the auction. Furthermore, the remaining time is set to the auction, based on the end date and time. In this way, a unique auction ID is set to the exhibition information including the various parameters set to the corresponding auction, and the exhibition information and the auction ID are registered in the auction information database 21 in association with each other.

By the way, when the prompt decision price is set in the setting of the parameters, a reference price is set to the auction according to the prompt decision price. The reference price is a price that is to be compared with the highest bid price in the bid price monitoring target auction to be described below. The exhibition reception processing unit 41, for example, sets the same price as the prompt decision price, or a price lower than the prompt decision price as the reference price. For example, when the prompt decision price is “1500 yen”, the reference price is set to “1500 yen”. Alternatively, the reference price is set to “1350 yen” (price 10% lower than the prompt decision price). When the price lower than the prompt decision price is set as the reference price, the exhibition reception processing unit 41 may set the reference price according to a bid unit based on the prompt decision price. Herein, the bid unit is a minimum price to be added to the highest bid price when making a bid with a bid price higher than the highest bid price. For example, when the bid price is “equal to or more than 0 yen and less than 1000 yen”, the bid unit is set to, for example, 10 yen. When the bid price is “equal to or more than 1000 yen and less than 5000 yen”, the bid unit is set to, for example, 100 yen. The bid unit based on the prompt decision price means a bid unit when it is assumed to make a bid with, for example, a bid price equal to the prompt decision price or closer to the prompt decision price by a predetermined amount. For example, when the prompt decision price is “1500 yen”, the bid price equal to the prompt decision price or closer to the prompt decision price by a predetermined amount is included between equal to or more than 0 yen and less than 1000 yen. Therefore, the bid unit based on the prompt decision price is set to “100 yen”. According to the bid unit based on the prompt decision price, for example, “100 yen”, “1400 yen” lower than the prompt decision price “1500 yen” by “100 yen” is set as the reference price, or “1300 yen” lower than the prompt decision price “1500 yen” by “200 yen” (two times the bid unit) is set as the reference price. Therefore, the configuration that sets the reference price according to the bid unit based on the prompt decision price can match the unit of the reference price to the unit by which the highest bid price is increased. Therefore, the calculation can be performed more quickly. Also, the reference price may be configured to be registered in association with the prompt decision price set immediately before the exhibition information is registered in the auction information database 21, or may be configured to be set when compared with the highest bid price in the bid price monitoring target auction to be described below.

The bid reception processing unit 42 performs, for example, a process of providing a web page, which allows a bid to an auction, to the user terminal Tn, a process of acquiring bid information from the user terminal Tn of the bidder of auction, a process of registering bid information, a process of registering the number of bids, and the like. Herein, the bid information includes, for example, information on an auction ID of a bid target auction, a bidder ID, a bid date and time, a bid price, and the like. Then, the bid information is registered in the auction information database 21 in association with the auction ID matched with the auction ID included in the bid information. Herein, the registered bid price is the highest bid price (maximum bid price) at the time point of registration.

The successful bid processing unit 43 performs a successful bid process when the bid price included in the bid information is equal to or more than the prompt decision price, or when the remaining time becomes “0”. The successful bid process notifies information to the effect that a successful bid for an item was made, to the successful bidder (bidder who first designated the bid price equal to or more than the prompt decision price, or bidder who designated the highest bid price when the remaining time became “0”) and the exhibitor of auction.

The alert notification target specifying unit 44 specifies an auction in which the prompt decision price has been set and which has been unfinished, from the auction information database 21, as the alert notification target auction. The alert notification target auction is an auction targeted for notification of an alert to a bidder of auction or a certain user probable to make a bid.

The bid price monitoring target specifying unit 45 specifies other auction in which at least one of the item name and the item code of the item exhibited in the corresponding auction is matched and which has been unfinished, from the auction information database 21, as the bid price monitoring target auction, the item name and the item code being included in the information on the alert notification target auction (for example, exhibition information). The bid price monitoring target auction is an auction targeted for monitoring the highest bid price in order for comparison with the reference price set to the alert notification target auction.

When the highest bid price in the bid price monitoring target auction specified by the bid price monitoring target specifying unit 45 satisfies a predetermined condition for the reference price according to the prompt decision price set to the alert notification target auction specified by the alert notification target specifying unit 44 (that is, auction where at least one of the item name and the item code is matched in the bid price monitoring target auction), the alert notification processing unit 46 notifies the alert to at least one of the bidder of the alert notification target auction, to which the prompt decision price is set, and a certain user probable to make a bid in the corresponding alert notification target auction.

### [2. Operation of Auction Processing System]

Next, the operation of the auction processing system S according to the present embodiment will be described. Also, on the premise of the operation to be described below, it is assumed that an unfinished auction where the prompt decision price is set is registered in the auction information database 21.

### [2.1 Bid Operation in Auction]

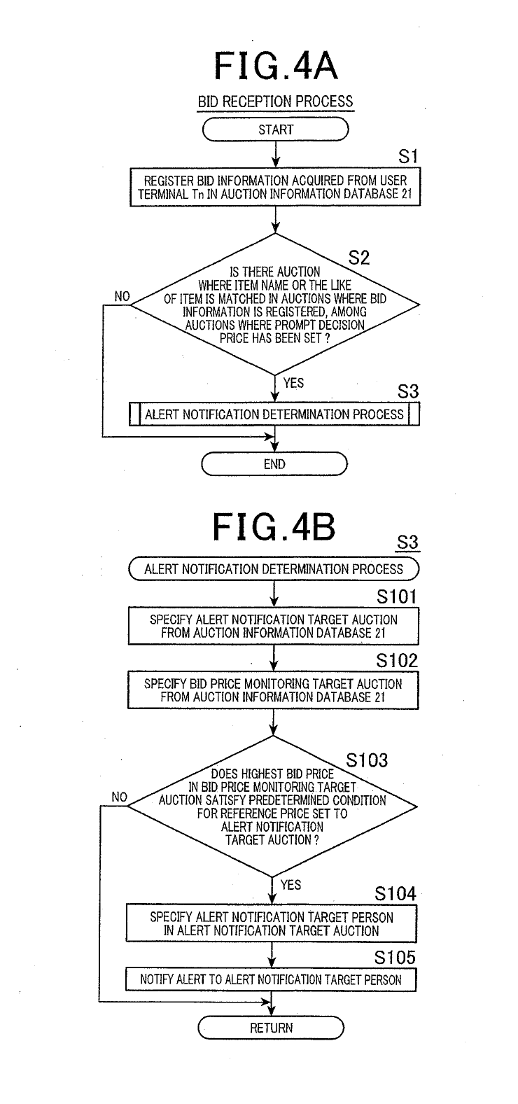

First, the bid operation in the auction will be described with reference to FIGS. 4A and 4B. FIG. 4A is a flowchart illustrating an example of a bid reception process in the system control unit 4 of the information processing server SA. FIG. 4B is a flowchart illustrating details of an alert notification determination process of step S3 of FIG. 4A.

After the login process of the user of the user terminal Tn having made an access through the network NW, the system control unit 4 of the information processing server SA transmits the web page for designating the bid information to the user terminal Tn so that the web page is displayed by the web browser. Therefore, when the user of the user terminal Tn as the bidder of auction performs a bid instruction by designating the bid information (for example, by inputting or selecting the bid information by the operation unit) (for example, when the user of the user terminal Tn presses a bid button) on the web page displayed on the display of the user terminal Tn, the designated bid information is transmitted from the user terminal Tn through the network NW to the information processing server SA.

In this way, when receiving and acquiring the bid information from the user terminal Tn, the system control unit 4 of the information processing server SA starts the bid reception process illustrated in FIG. 4A. When the process illustrated in FIG. 4A is started, the bid reception processing unit 42 of the system control unit 4 registers the corresponding bid information in the auction information database 21 in association with the auction ID matched with the auction ID included in the bid information acquired from the user terminal Tn (step S1). At this time, the bid reception processing unit 42 registers the number of bids in the auction information database 21 after incrementing it by 1.

Subsequently, the bid reception processing unit 42 of the system control unit 4 retrieves auctions in which the prompt decision price has been set and which has been unfinished with reference to the auction information database 21, and determines whether there are auctions where at least one of the item name and the item code of the item exhibited in the auction where the bid information is registered in step S1 is matched, among the retrieved auctions (step S2). For example, when the auction where the item code matched with the item code of the item exhibited in the auction where the bid information has been registered in step S1 is included in the exhibition information is registered in the auction information database 21, it is determined in step S2 that there is the auction (it is determined that the condition is satisfied) (step S2: YES), and the process proceeds to step S3. On the other hand, when it is determined that there is not the auction (step S2: NO), and the bid reception process illustrated in FIG. 4A is ended.

In step S3, the system control unit 4 performs an alert notification determination process. In the alert notification determination process, as illustrated in FIG. 4B, first, the alert notification target specifying unit 44 of the system control unit 4 specifies the auction determined as satisfying the condition in step S2 (auction where the prompt decision price has been set) (for example, specifies the auction by the auction ID), from the auction information database 21, as the alert notification target auction (step S101).

Subsequently, the bid price monitoring target specifying unit 45 of the system control unit 4 specifies the auction where the bid information has been registered in step S1 (for example, specifies the auction by the auction ID), from the auction information database 21, as the bid price monitoring target auction (step S102). That is, the bid price monitoring target auction specified herein is other auction in which at least one of the item name and the item code of the item exhibited in the corresponding auction is matched and which has not been finished, the item name and the item code being included in the exhibition information specified in step S101.

Subsequently, the alert notification processing unit 46 of the system control unit 4 determines whether the highest bid price in the bid price monitoring target auction specified in step S102 satisfies a predetermined condition for the reference price according to the prompt decision price set to the alert notification target auction specified in step S101 (step S103). In other words, it is determined whether the result of comparison between the highest bid price in the bid price monitoring target auction and the reference price set to the alert notification target auction satisfies a preset condition. Before the determination, the alert notification processing unit 46 acquires the highest bid price in the bid price monitoring target auction by acquiring the current price associated with the auction ID of the bid price monitoring target auction specified in step S102, from the auction information database 21. Furthermore, the alert notification processing unit 46 acquires the prompt decision price associated with the auction ID of the alert notification target auction specified in step S101 or the reference price according to the corresponding prompt decision price, from the auction information database 21. When the prompt decision price is acquired, the reference price is set according to the corresponding prompt decision price at the time of the determination of step S103. Also, when the prompt decision price is equal to the reference price, the prompt decision price is set as the reference price.

Also, examples of the “predetermined condition” may include “the highest bid price is more than the reference price (exceeds the reference price”, “the highest bid price is equal to or more than the reference price”, and the like. In other words, it can be said that “the highest bid price is more than the reference price” is “a value obtained by subtracting the reference price from the highest bid price is greater than 0”. Such condition is set based on, for example, the concept of detecting in advance the probability that the bidder bidding at the bid price monitoring target auction will bid at the alert notification target auction. Therefore, other conditions may also be set as long as the conditions are based on such concept. For example, a condition that “even when the highest bid price is smaller than the reference price, a change in the highest bid price per unit time is equal to or greater than a predetermined value (that is, a rising speed of the highest bid price is fast (a rising slope is great))” may be set.

Then, when it is determined in step S103 that the highest bid price in the bid price monitoring target auction does not satisfy the predetermined condition for the reference price according to the prompt decision price set to the alert notification target auction (step S103: NO), the alert notification determination process illustrated in FIG. 4B is ended. On the other hand, when it is determined that the highest bid price in the bid price monitoring target auction satisfies the predetermined condition for the reference price according to the prompt decision price set to the alert notification target auction (step S103: YES), the process proceeds to step S104.

In step S104, the alert notification processing unit 46 of the system control unit 4 specifies (for example, specifies by an user ID) at least one user (alert notification target person) of a bidder bidding at the alert notification target auction specified in step S101 (for example, alert notification target auction determined as satisfying the predetermined condition in step S103 above) and a potential bidder probable to bid at the alert notification target auction.

For example, the alert notification processing unit 46 specifies the bidder ID (user ID) associated with the auction ID of the alert notification target auction, from the auction information database 21. Also, the alert notification processing unit 46 specifies the user ID associated with the watch list registration history including the auction ID of the alert notification target auction, from the user information database 22 as a user ID of a certain potential bidder probable to bid at the alert notification target auction with reference to the user information database 22. The potential bidder is a watch list registrant who is relatively highly probable to bid at an auction.

Incidentally, the alert notification processing unit 46 may be configured to specify the user ID associated with the browsing history including the auction ID of the alert notification target auction, from the user information database 22 as an user ID of a certain potential bidder probable to bid at the alert notification target auction with reference to the user information database 22, but since a load applied on the information processing server SA and the network NW is increased when a range of the alert notification target persons is widened, it is preferable to have a configuration such that the alert notification target persons are narrowed to the bidder of the alert notification target auction and the watch list registrant. Also, there is a case where the number of auctions is enormous according to an item type. For example, in this case, when it is configured such that the alert notification target persons are narrowed to the bidder of the alert notification target auction, a load applied on the information processing server SA and the network NW can be reduced.

Also, the alert notification processing unit 46 may be configured to determine the range of the alert notification target persons (range of users to which the alert is to be notified), based on the number of biddable auctions. For example, the alert notification processing unit 46 acquires the number of the alert notification target auctions, which are specified by the alert notification target specifying unit 44 in step S101 above, as the number of the biddable auctions. Alternatively, the alert notification processing unit 46 may be configured to acquire the number of the alert notification target auctions, which are determined as satisfying the predetermined condition in step S103 above, as the number of the biddable auctions. Then, the alert notification processing unit 46 determines the range of the alert notification target persons, based on the acquired number of the auctions. For example, when the acquired number of the auctions is greater than a preset reference number (for example, 2 to 4), the alert notification processing unit 46 narrowly determines the range of the alert notification target persons, just like by limiting (prioritizing) the alert notification target persons to, for example, the bidder of the alert notification target auction. This is because the supply of the auctions of the same items are sufficient, and thus, other biddable auctions are sufficient, without notifying an alert to the watch list registrant of the alert notification target auction or the visitor of the alert notification target auction. Therefore, a load applied on the information processing server SA and the network NW can be reduced. On the other hand, when the acquired number of the auctions is smaller than the preset reference number, the alert notification processing unit 46 widely determines the range of the alert notification target persons, just like by setting the alert notification target persons to, for example, the bidder of the alert notification target auction, the watch list registrant of the alert notification target auction, and the visitor of the alert notification target auction (even only the bidder of alert notification target auction and the watch list registrant of the alert notification target auction are enough). This is because, since the supply of the auctions of the same items is not sufficient, for example, the bidder of the bid price monitoring target auction is highly probable to move to the alert notification target auction the watch list registrant registers, and make a bid, and in this case, other biddable auction is probable to be ended to the watch list registrant. According to the configuration that determines the range of the alert notification target persons based on the number of the biddable auctions, the alert can be notified in consideration of the load applied on the network NW and the necessity of the alert notification.

Then, the alert notification processing unit 46 of the system control unit 4 notifies an alert to the user (alert notification target persons) specified in step S104 (step S105). For example, the alert notification processing unit 46 registers an alert notification flag in the user information database 22 in association with the user ID of the user specified in step S104, and notifies an alert, for example, by displaying alert information indicating that the bidder of the bid price monitoring target auction is probable to bid at the alert notification target auction, on the web page displayed on the user terminal Tn when the corresponding user logs in from the user terminal Tn. Alternatively, the alert notification processing unit 46 notifies an alert by transmitting an email, in which the alert information is described, to an email address destination associated with the user ID of the user specified in step S104, and ends the processes illustrated in FIGS. 4A and 4B.

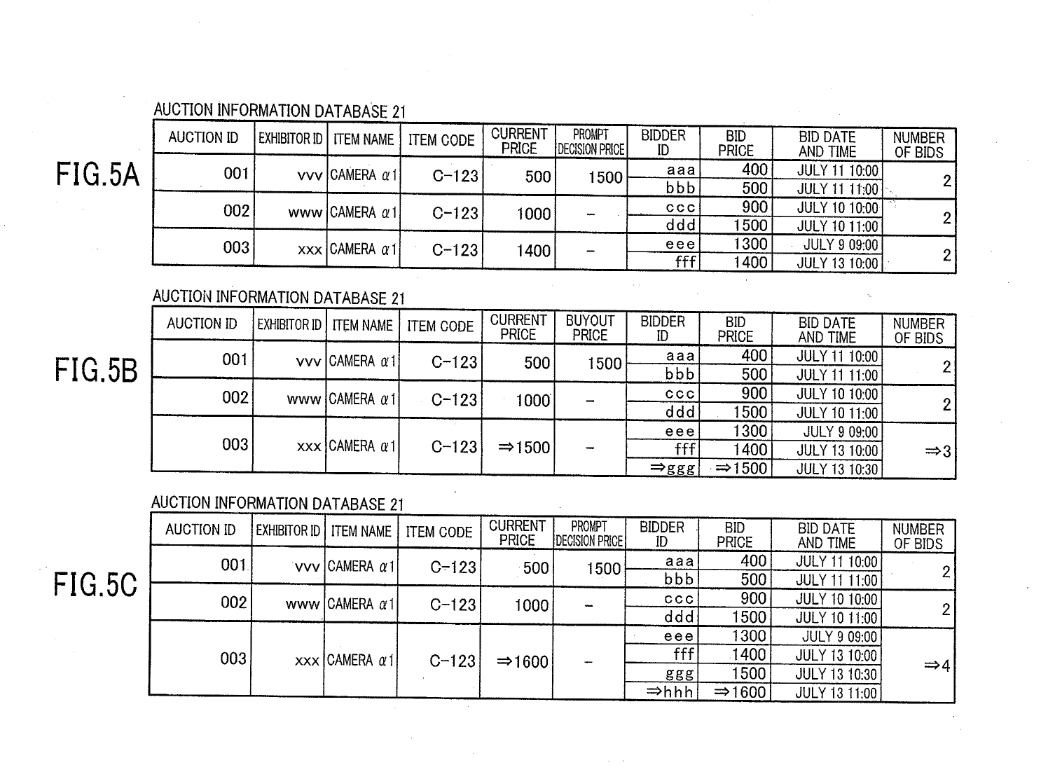

The above bid reception process is performed whenever the bid information is received from the user terminal Tn. However, in a case where there are multiple bids at the same bid price monitoring target auction, a specific example of whether a predetermined condition is satisfied in each step S103 will be described with reference to FIG. 5. FIG. 5 is a diagram illustrating an example (part) of information registered in the auction information database 21 in the condition determination of each step S103. Incidentally, in examples illustrated in FIGS. 5A to 5C, information associated with an auction ID “001” is information on the alert notification target auction. Information associated with auction IDs “002” and “003” is information on the bid price monitoring target auction where the bid information is registered in step S1. In the following description, an alert notification target auction of an auction ID “001” and a bid price monitoring target of an auction ID “003” will be taken as an example. In a case where the “predetermined condition” in step S103 is set as “the highest bid price is more than the reference price” and the reference price in the alert notification target auction of the auction ID “001” is set to, for example, 1400 yen according to bid unit (for example, 100 yen) based on the prompt decision price (1500 yen), the condition is not satisfied when a bid is made at the current price (highest bid price) “1400 yen” in the bid price monitoring target auction of the auction ID “003” illustrated in FIG. 5A, but the condition is satisfied when a bid is made at the current price (highest bid price) “1500 yen” in the bid price monitoring target auction of the auction ID “003” illustrated in FIG. 5B. Under such a condition, in step S105, since the alert can be quickly notified to the bidder of the alert notification target auction or the like, the bidder of the alert notification target auction or the like can cope with a situation that the bidder of the bid price monitoring target auction moves to the alert notification target auction and makes a bid, while keeping his or her composure.

On the other hand, in a case where the “predetermined condition” is set as “the highest bid price is more than the reference price” and the reference price in the alert notification target auction of the auction ID “001” is set to the same as the prompt decision price (1500 yen), the condition is not satisfied when a bid is made at the current price (highest bid price) “1400 yen” in the bid price monitoring target auction of the auction ID “003” illustrated in FIG. 5A and when a bid is made at the current price (highest bid price) “1500 yen” in the bid price monitoring target auction of the auction ID “003” illustrated in FIG. 5B, but the condition is satisfied when a bid is made at the current price (highest bid price) “1600 yen” in the bid price monitoring target auction of the auction ID “003” illustrated in FIG. 5C. In the bid price monitoring target auction of the auction ID “003” illustrated in FIG. 5C, a bidder of a bidder ID “ggg” made a bid at the highest bid price equal to the reference price (1500 yen) but a bidder of a bidder ID “hhh” made a bid at 1600 yen. Hence, the bidder of the bidder “ggg” is a bidder who lost an authority to bid successfully for a corresponding item. The bidder who lost the authority to bid successfully already specifies that he or she will pay the reference price (1500 yen) for the corresponding item. Thus, in particular, if the bidder has a policy that will not make a bid at 1600 yen or more, he or she is highly probable to move from the bid price monitoring target auction of the auction ID “003” to the alert notification target auction of the auction ID ‘001” and make a bid. Therefore, under such a condition, in step S105, the alert can be notified more efficiently (without loss) to the bidder of the alert notification target auction or the like, and the number of alert notifications can also be reduced. Hence, a load applied on the information processing server SA and the network NW can be reduced.

Also, when it is determined in step S103 above that the highest bid price in the bid price monitoring target auction satisfies the predetermined condition for the reference price according to the prompt decision price set to the alert notification target auction, the alert notification processing unit 46 is configured to notify the alert to the alert notification target person specified in step S104. However, when the bidder of the bid price monitoring target auction is less probable to bid at the alert notification target auction, there is a case where the need to notify the alert to the alert notification target person is low. Therefore, the alert notification processing unit 46 may be configured to determine whether to notify the alert, based on a past bid history or purchase history of a bidder who made a bid at the bid price monitoring target auction specified in step S102 above. Therefore, since the number of notifications of the alert of which the need is low can be reduced, a load applied on the information processing server SA and the network NW can be reduced.

For example, the alert notification processing unit 46 determines whether the bidder of the bid price monitoring target auction is a user who made a bid more than a predetermined number of times in a past auction, based on the past bid history of the bidder of the bid price monitoring target auction specified in step S102. For example, the alert notification processing unit 46 uses the bidder ID of the bidder of the bid price monitoring target auction as a key to specify the auction, where the corresponding bidder made a bid in the past, from the auction information database 21, and determines whether the bidder is a user who made a bid more than a predetermined number of times, with reference to the bid history of the corresponding auction (for example, the number of bids). Herein, the term “bid” as used herein refers to returning a bid in response to (against) other bid. The past auction may be an unfinished auction or may be an already finished auction. The phrase “more than a predetermined number of times in a past auction” means more than a predetermined number of times in a certain auction where the bidder of the bid price monitoring target auction made a bid in the past. The number of times is preset to, for example, about five times. Then, when it is determined that the bidder of the bid price monitoring target auction is a user who made a bid more than the predetermined number of times in the past auction, the alert notification processing unit 46 notifies the alert to the alert notification target person. Therefore, the alert is notified to the alert notification target person only when it is highly probable to move to and make a bid at the alert notification target auction, just like a user who has a competitive spirit to return a bid when a bid is made to other person. Therefore, a load applied to the information processing server SA and the network NW can be reduced.

As another example, the alert notification processing unit 46 determines whether the bidder of the bid price monitoring target auction is a user who made a successful bid for an item at the prompt decision price in the past auction, based on the past bid history of the bidder of the bid price monitoring target auction specified in step S102 above. For example, the alert notification processing unit 46 uses the bidder ID of the bidder of the bid price monitoring target auction as a key to specify the auction, where the corresponding bidder made a bid in the past, from the auction information database 21, and determines whether the bidder is a user who made a successful bid for the item at the prompt decision price, with reference to the bid history of the corresponding auction. Then, when it is determined that the bidder of the bid price monitoring target auction is a user who made a successful bid for an item at the prompt decision price in the past auction, the alert notification processing unit 46 notifies the alert to the alert notification target person. Therefore, the alert is notified to the alert notification target person only when it is highly probable to move to and make a bid at the alert notification target auction, just like a user who experienced a successful bid at a prompt decision price in the past. Therefore, a load applied to the information processing server SA and the network NW can be reduced.

Furthermore, as another example, the alert notification processing unit 46 determines whether the bidder of the bid price monitoring target auction is a user who purchased the same item a plurality of number of times, based on the past purchase history of the bidder of the bid price monitoring target auction specified in step S102 above. For example, the alert notification processing unit 46 uses the bidder ID of the bidder of the bid price monitoring target auction as a key to specify the purchase history of the corresponding bidder, from the user information database 22 (the purchase history may be specified from the auction information database 21), and determines whether the bidder is a user who purchased the same item a plurality of number of times, with reference to the corresponding purchase history. Then, when it is determined that the bidder of the bid price monitoring target auction is a user who purchased the same item a plurality of number of times, the alert notification processing unit 46 notifies the alert to the alert notification target person. Therefore, the alert is notified to the alert notification target person only when it is highly probable to make a bid at the alert notification target auction, just like a user who is highly probable to make a bid at a plurality of auctions where the same item is exhibited. Therefore, a load applied to the information processing server SA and the network NW can be reduced.

### (2.2 Periodic Alert Notification Determining Operation)

Next, the periodic alert notification determination operation will be described with reference to FIG. 4B.

In the operation of the above [2.1], the alert notification determination process illustrated in FIG. 4B is configured to be performed in the bid reception process. However, as another example, the alert notification determination process illustrated in FIG. 4B may be configured to be performed without regard to the bid reception process. In this case, the alert notification determination process illustrated in FIG. 4B is repeatedly performed at predetermined time intervals (for example, five minutes).

In this case, in step S101 illustrated in FIG. 4B, the alert notification target specifying unit 44 of the system control unit 4 specifies an unfinished auction, where the prompt decision price is set, from the auction information database 21, as the alert notification target auction (for example, specifies the unfinished auction by the auction ID). Also, a process of a case where a plurality of alert notification target auctions is specified will be described below.

Then, the bid price monitoring target specifying unit 45 of the system control unit 4 specifies other auction where at least one of the item name and the item code of the item exhibited in the corresponding auction is matched and other auction which has not been finished, as the bid price monitoring target auction (for examples, specifies the auction by the auction ID), the item name and the item code being included in the exhibition information of the alert notification target auction specified in step S101 (step S102).

Then, in a manner similar to the above-described bid operation, processes of steps S103 to S105 are performed. In this case, the alert notification processing unit 46 may be configured to determine whether to notify the alert, based on the past bid history or purchase history of the bidder who made a bid at the bid price monitoring target auction specified in step S102 above.

Then, after the process of step S105, the alert notification target specifying unit 44 of the system control unit 4 determines whether an alert notification target auction, which is unspecified in step S101, exists in, for example, the auction information database 21. When the unspecified alert notification target auction exists, the alert notification target specifying unit 44 returns to step S101 to specify the unspecified alert notification target auction and repeat the same process as above. On the other hand, when the unspecified alert notification target auction does not exist, the alert notification determination process illustrated in FIG. 4B is ended, and the alert notification determination process is on standby until an execution trigger of a next alert notification determination process arrives.

As described above, according to the above-described embodiment, the information processing server SA is configured to specify the alert notification target auction where the prompt decision price has been set, to specify the bid price monitoring target auction where at least one of the item name and the item code of the item exhibited in the corresponding alert notification target auction, and to notify the alert to a user of at least one of the bidder who makes a bid at the alert notification target auction, where the prompt decision price has been set, and a certain potential bidder who is probable to make a bid at the corresponding auction, when the highest bid price in the corresponding bid price monitoring target auction satisfies the predetermined condition for the reference price according to the prompt decision price set to the corresponding alert notification target auction. Therefore, before other user in the bid price monitoring target auction makes a bid at the alert notification target auction, the probability of the bid by the corresponding other user can be notified to the user of the alert notification target auction. Therefore, the damage of the user's benefit of the alert notification target auction can be reduced. Therefore, it is possible to allow the corresponding user to participate in the alert notification target auction with an easy mind.

(2.3 Alert Notification Determining Operation of Case where a Plurality of Alert Notification Target Auctions is Present)

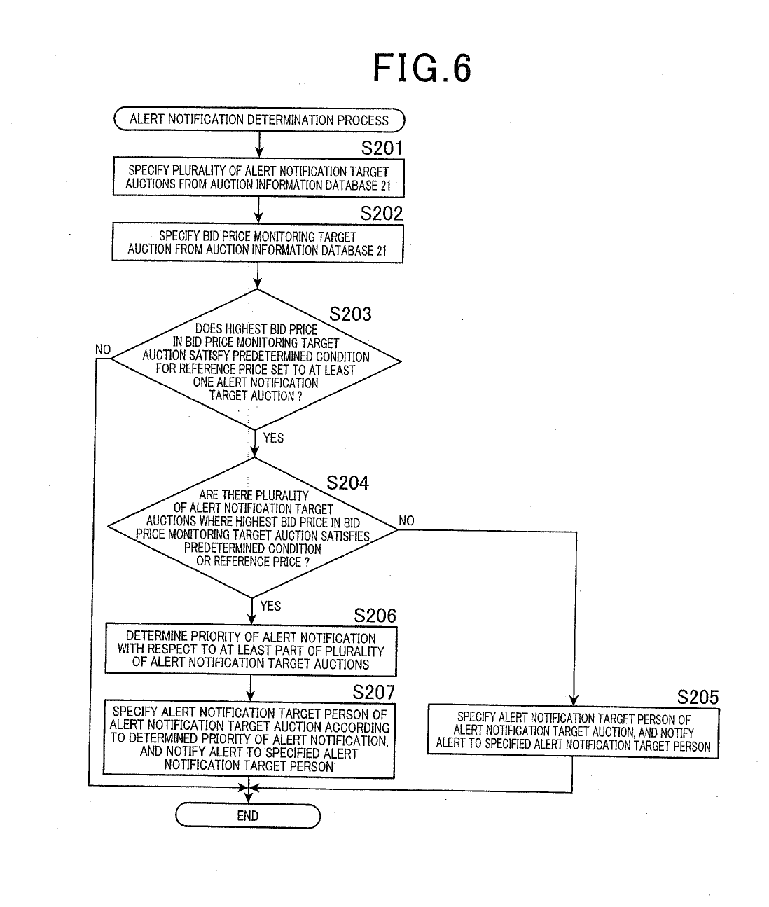

Next, the alert notification determination process of a case where a plurality of alert notification target auctions satisfying a predetermined condition is present will be described with reference to FIG. 6 and the like. FIG. 6 is a flowchart illustrating a modification of the alert notification determination process illustrated in FIG. 4B. The alert notification determination process illustrated in FIG. 6 is performed instead of the alert notification determination process illustrated in FIG. 4B in the above [2.1] and the operation of [2.1].

In step S201 illustrated in FIG. 6, the alert notification target specifying unit 44 of the system control unit 4 specifies a plurality of alert notification target auctions (unfinished auctions where the prompt decision price is set) where at least one of the item name and the item code of the exhibited item is matched with each other (determined by item specification information), from the auction information database 21 (for example, specifies the alert notification target auctions by the auction ID).

Then, other auction in which at least one of the item name and the item code of the item exhibited in the corresponding auction is matched and which has not been finished are specified as the bid price monitoring target auction, from the auction information database 21 (for examples, specifies the auction by the auction ID), the item name and the item code being included in the exhibition information of the alert notification target auction specified in step S201 (step S202).

Subsequently, the alert notification processing unit 46 of the system control unit 4 determines whether the highest bid price in the bid price monitoring target auction specified in step S202 satisfies a predetermined condition for the reference price according to the prompt decision price set to each alert notification target auction specified in step S201, with respect to each alert notification target auction (step S203). Then, when it is determined that the highest bid price in the bid price monitoring target auction does not satisfy the predetermined condition for the reference price according to the prompt decision price set to each alert notification target auction (step S203: NO), the alert notification determination process illustrated in FIG. 6 is ended. On the other hand, when it is determined that the highest bid price in the bid price monitoring target auction satisfies the predetermined condition for the reference price according to the prompt decision price set to at least one alert notification target auction (step S203: YES), the process proceeds to step S204.

In step S204, the alert notification processing unit 46 of the system control unit 4 determines whether there is a plurality of alert notification target auctions where the highest bid price in the bid price monitoring target auction satisfies the predetermined condition for the reference price. Then, when it is determined that there is not a plurality of alert notification target auctions (that is, there is one alert notification target auction) where the highest bid price in the bid price monitoring target auction satisfies the predetermined condition for the reference price (step S204: NO), the process proceeds to step S205. On the other hand, when it is determined that there is a plurality of alert notification target auctions where the highest bid price in the bid price monitoring target auction satisfies the predetermined condition for the reference price (step S204: YES), the process proceeds to step S206.

In step S205, in a manner similar to step S104 and S105 above, the alert notification processing unit 46 of the system control unit 4 specifies an alert notification target person in the alert notification target auction determined in step S203 as satisfying the predetermined condition, and notifies the alert to the specified alert notification target person.

In step S206, the alert notification processing unit 46 of the system control unit 4 determines a priority of the alert notification with respect to at least a part of the plurality of alert notification target auctions determined in step S203 as satisfying the predetermined condition. The priority of the alert notification is a parameter indicating which one of the plurality of alert notification target auctions is prioritized when performing the alert notification. As the alert notification target auction has a large (higher) priority of the alert notification, the alert is preferentially notified to the alert notification target person. For example, the priority of the alert notification is represented by, for example, “large”, “medium’, and “small” (the priority of the alert notification may be represented by numeric values). The alert is most preferentially notified to the alert notification target person of the alert notification target auction determined as the “large” priority. Also, the priority may not be determined with respect to all alert notification target auctions determined in step S203 as satisfying the predetermined condition. That is, it is only necessary to determine the priority of as many alert notification target auctions as the number corresponding to a demand. The notification of the alert to the alert notification target person of the alert notification target auction of which the priority has not been determined is performed after the alert is notified to the alert notification target person of the alert notification target auction of which the priority has been determined. Alternatively, it may be configured not to perform the notification of the alert to the alert notification target person of the alert notification target auction of which the priority has not been determined.

Herein, an example of a method of determining a priority of an alert notification will be described separately in priority determining methods a to d.

(Priority Determining Method a)

First, in the priority determining method a, the alert notification processing unit 46 determines the priority of the alert notification with respect to at least a part of the plurality of alert notification target auctions, based on a magnitude relationship of the prompt decision prices set to each alert notification target auction determined in step S203 as satisfying the predetermined condition.

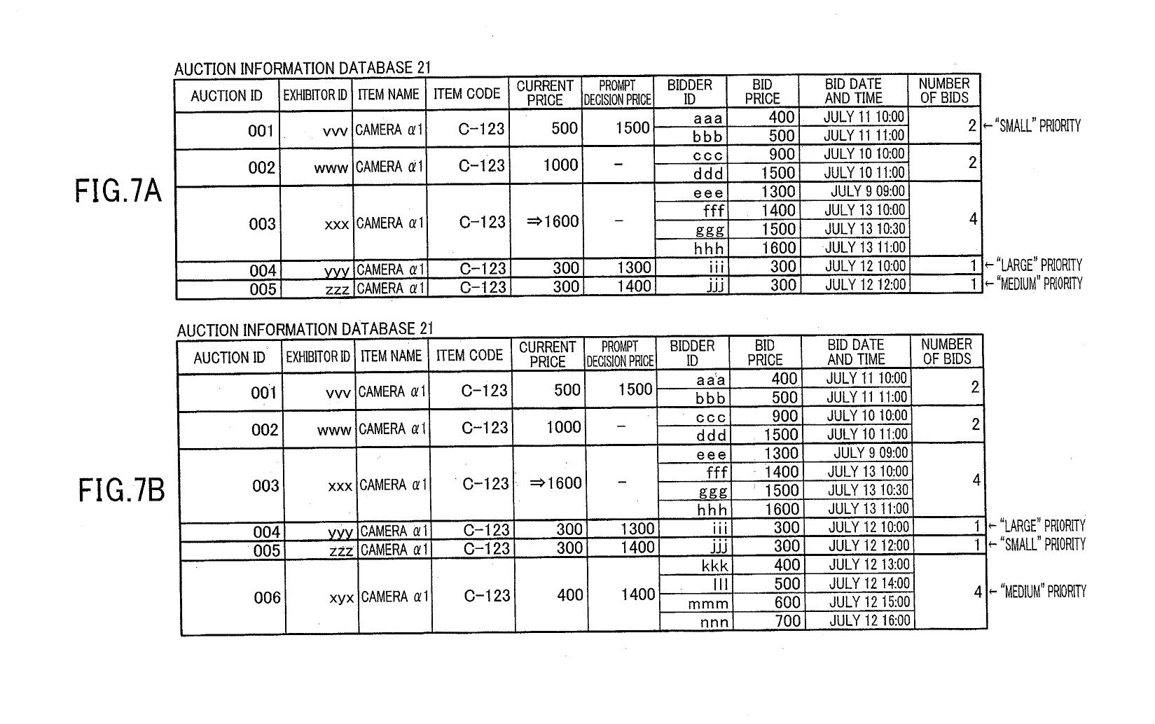

FIGS. 7A and 7B are diagrams illustrating an example (part) of information registered in the auction information database 21 in the process of step S206. In the example illustrated in FIG. 7A, information associated with auction IDs “001”, “004” and “005” is information on the alert notification target auctions determined in step S203 as satisfying the predetermined condition, respectively, and information associated with auction IDs “002” and “003” is information on the bid price monitoring target auctions, respectively (FIG. 7B is the same as above). Then, in the example illustrated in FIG. 7A, the prompt decision price set to the alert notification target auction of the auction ID “001” is “1500 yen”, which is greatest (high), and the prompt decision price set to the alert notification target auction of the auction ID “004” is “1300 yen”, which is smallest (low), The bidder of the bid price monitoring target auction is highly probable to move to and bid at the alert notification target auction of the auction ID “004”, of which the prompt decision price is smallest, and the urgency of the alert notification is high. Therefore, based on the magnitude relationship of the prompt decision prices, for example, the priority of the alert notification with respect to the alert notification target auction of the auction ID “004” is determined as “large”, the priority of the alert notification with respect to the alert notification target auction of the auction ID “005” is determined as “meddle”, and the priority of the alert notification with respect to the alert notification target auction of the auction ID “001” is determined as “small”

According to the priority determining method a, the alert can be preferentially notified to the alert notification target person of the alert notification target auction of which the urgency of the alert notification is higher. In addition, a load applied on the information processing server SA and the network NW can be reduced, as compared with the case where the same alert is notified to the alert notification target persons of all alert notification target auctions determined as satisfying the above condition, without determining the priority of the alert notification.

(Priority Determining Method b)

Next, in the priority determining method b, the alert notification processing unit 46 determines the priority of the alert notification with respect to auctions of at least a part of the plurality of alert notification target auctions, according to a usage time zone based on an auction usage result by a bidder who makes a bid at each alert notification target auction determined in step S203 as satisfying the predetermined condition, and a current time (for example, time of the process of step S206). Herein, time zone information indicating the usage time zone based on the auction usage result by the bidder is acquired from the auction information database 21 by using the bidder ID of the corresponding bidder as a key. Examples of the auction usage result include auction exhibition result, bid result, or watch list registration result. The auction usage result includes information on time used. Therefore, it is possible to determine at which time zone the corresponding bidder accesses the auction site and uses the auction. For example, if the corresponding bidder (statistically) tends to make a bid and exhibit an item at an auction in a time zone of 1 to 2 o'clock at midnight and the current time is 1 p.m., the bidder is highly probable to immediately access no auction site even when the alert is notified to the corresponding bidder. Therefore, it is considered that there is no effect of the alert. Therefore, when the current time is included in the usage time zone based on the auction usage result by the bidder who makes a bid at the alert notification target auction, the priority of the alert notification with respect to the corresponding alert notification target auction is determined as, for example, “large”. On the other hand, when the current time is not included in the usage time zone based on the auction usage result by the bidder who makes a bid at the alert notification target auction, the priority of the alert notification with respect to the corresponding alert notification target auction is not determined or is determined as, for example, “small”.

According to the priority determining method b, the alert can be preferentially notified to the alert notification target person who can respond to the alert notification. In addition, a load applied on the information processing server SA and the network NW can be reduced, as compared with the case where the same alert is notified to the alert notification target persons of all alert notification target auctions determined as satisfying the above condition, without determining the priority of the alert notification.

(Priority Determining Method c)

Next, in the priority determining method c, the alert notification processing unit 46 determines the priority of the alert notification with respect to the alert notification target auction browsed or registered in the watch list after the bid of the corresponding bid price monitoring target auction by the bidder who makes a bid at the bid price monitoring target auction specified in step S202. Herein, the bid date and time when the corresponding bidder made a bid at the bid price monitoring target auction is acquired from the auction information database 21 by using the auction ID of the corresponding bid price monitoring target auction and the bidder ID of the corresponding bidder as a key. The browsing date and time when the alert notification target auction was browsed by the bidder of the bid price monitoring target auction is acquired from the browsing history registered in the user information database 22 by using the auction ID of the corresponding alert notification target auction and the bidder ID of the corresponding bidder as a key. On the other hand, the registration date and time when the alert notification target auction was registered in the watch list by the bidder of the bid price monitoring target auction is acquired from the watch list registration history registered in the user information database 22 by using the auction ID of the corresponding alert notification target auction and the bidder ID of the corresponding bidder as a key.

The alert notification processing unit 46 compares the acquired bid date and time with the browsing date and time or the registration date and time to specify the alert notification target auction browsed or registered in the watch list after the bid of the corresponding bid price monitoring target auction. Since it can be considered that such a specified alert notification target auction is an auction in which the bidder of the bid price monitoring target auction is interested, the corresponding bidder is highly probable to move to and bid at the alert notification target auction, and the urgency of the alert notification is high. Therefore, the priority of the alert notification with respect to such a specified alert notification target auction is determined as, for example, “large”. On the other hand, the priority of the alert notification is not determined or is determined as “small” with respect to the alert notification target auction that was not browsed and not registered in the watch list after the bid of the bid price monitoring target auction by the bidder.

According to the priority determining method c, the alert can be preferentially notified to the alert notification target person of the alert notification target auction of which the urgency of the alert notification is higher. In addition, a load applied on the information processing server SA and the network NW can be reduced, as compared with the case where the same alert is notified to the alert notification target persons of all alert notification target auctions determined as satisfying the above condition, without determining the priority of the alert notification.

(Priority Determining Method d)

Next, in the priority determining method d, the alert notification processing unit 46 determines the priority of the alert notification with respect to auctions of at least a part of the plurality of alert notification target auctions, based on the browsing date and time when at least one page among the respective web pages capable of browsing the situation of the alert notification target auction determined in step S203 as satisfying the predetermined condition was browsed after the bid of the corresponding bid price monitoring target auction by the bidder who makes a bid at the bid price monitoring target auction specified in step S202. The browsing date and time when the respective web pages capable of browsing the situation of the alert notification target auction were browsed is acquired from the browsing history registered in the user information database 22 by using the auction ID of the corresponding alert notification target auction and the bidder ID of the corresponding bidder as a key.

The alert notification processing unit 46 specifies the alert notification target auction of which the browsing time is, for example, earliest among the acquired browsing times. Since it can be considered that such a specified alert notification target auction is an auction in which the bidder of the bid price monitoring target auction is first interested, the corresponding bidder is highly probable to move to and bid at the alert notification target auction, and the urgency of the alert notification is high. Therefore, the priority of the alert notification with respect to such a specified alert notification target auction is determined as, for example, “large”. On the other hand, the priority of the alert notification is not determined or is determined as “small” with respect to the alert notification target auction that was not browsed and not registered in the watch list after the bid of the bid price monitoring target auction by the bidder.

According to the priority determining method d, the alert can be preferentially notified to the alert notification target person of the alert notification target auction of which the urgency of the alert notification is higher. In addition, a load applied on the information processing server SA and the network NW can be reduced, as compared with the case where the same alert is notified to the alert notification target persons of all alert notification target auctions determined as satisfying the above condition, without determining the priority of the alert notification.

Subsequently, the alert notification processing unit 46 of the system control unit 4 specifies an alert notification target person in the alert notification target auction determined in step S203 as satisfying the predetermined condition, according to the priority of the alert notification determined in step S206, and notifies the alert to the specified alert notification target person (step S207). For example, the alert notification processing unit 46 immediately notifies the alert to the alert notification target person of the alert notification target auction of which the priority is “large”, notifies the alert to the alert notification target person of the alert notification target auction of which the priority is “medium” after several minutes, and notifies the alert to the alert notification target person of the alert notification target auction of which the priority is “small” after several ten minutes. Alternatively, the alert notification processing unit 46 may be configured to notify the alert to the alert notification target persons of only the alert notification target auctions of which the priority is, for example, “large” and “medium”.

Also, in the alert notification determination process illustrated in FIG. 6, the alert notification processing unit 46 of the system control unit 4 may be configured to determine the priority of the alert notification in step S206, only when it is determined that the item is not an item targeted for multiple purchases in the respectively alert notification target auctions determined in step S203 as satisfying the predetermined condition. Whether the item is an item targeted for multiple purchases can be determined with reference to a database in which attribute information of the corresponding item is registered. For example, in the case of the item targeted for multiple purchases (for example, stationery or the like), it is highly probable to make a bid at the alert notification target auction, without regard to a successful bid at the bid price monitoring target auction. Therefore, in such a case, it is more preferable to equally notify the alert to the alert notification target persons of all alert notification target auctions determined in step S203 as satisfying the predetermined condition than to determine the priority of the alert and notify the alert. Therefore, when the item is not an item targeted for multiple purchases in the respectively alert notification target auctions determined in step S203 as satisfying the predetermined condition, the alert notification processing unit 46 determines the priority of the alert notification and notifies the alert. On the other hand, when the item is an item targeted for multiple purchases, the alert is quickly notified to the alert notification target persons of all alert notification target auctions, without determining the priority of the alert notification. According to such a configuration, whether to notify the alert without determining the priority or whether to determine the priority and notify the alert can be efficiently switched based on the attribute of the item.

Also, in the alert notification determination process illustrated in FIG. 6, the alert notification processing unit 46 of the system control unit 4 may be configured to determine the range of the alert notification target auction of which the priority of the alert notification is determined, based on the number of bidders who make a bid at the bid price monitoring target auction. In the example illustrated in FIG. 7B, the number of bidders who make a bid at the bid price monitoring target auction of the auction ID “003” is four persons, and three persons other than one final successful bidder among them are probable to move to the alert notification target auction. Therefore, it is necessary to notify the alert in the alert notification target auction of three-person servings probable to move. In other words, as the alert notification target auction targeted for the alert notification, three-person servings are sufficient. Therefore, the alert notification processing unit 46 acquires the number of bidders who make a bid at the bid price monitoring target auction before the process of step S206, and determines the range of the alert notification auction of which the priority of the alert notification is determined, based on the acquired number of the bidders. As the range, for example, the number smaller than the acquired number of the bidders by one person is determined. Then, the alert notification processing unit 46 determines the priority of the alert notification with respect to the alert notification target auctions of the determined range (number) (step S206). Also, the method of determining the priority of the alert notification is the same as described above. In the example illustrated in FIG. 7B, the alert notification target auctions determined in step S203 as satisfying the predetermined condition are four, that is, the auction IDs “001”, “004”, “005” and “006”. However, as the determined range, the priority of the alert notification is determined with respect to three alert notification target auctions of the auction IDs “004”, “005” and “006” (in this case, for example, the auction of the auction ID “001” is excluded from the alert notification target). According to such a configuration, processing load can be reduced because it is possible to prevent the priority of the alert notification from being determined beyond the need for the alert notification target auction.

### REFERENCE SIGN LIST

1 communication unit
2 storage unit
3 input/output interface unit
4 system control unit
5 system bus
Tn user terminal
SA information processing server
NW network

1-15. (canceled)

16. An information processing apparatus comprising:
at least one memory operable to store program code;
at least one processor operable to read said program code and operate as instructed by said program code, said program code including:
first specifying code that causes said at least one processor to specify an auction in which a prompt decision price has been set and which has been unfinished, from a storage that stores information on an auction of an exhibited item with respect to each of a plurality of auctions;
second specifying code that causes said at least one processor to specify another auction in which at least one of an item name and an item code of the item exhibited in the auction is matched and which has been unfinished, from the storage, the item name and the item code being included in the information on the auction specified by the first specifying code; and
notifying code that, when a highest bid price in the other auction specified by the second specifying code satisfies a predetermined condition for a reference price according to the prompt decision price set to the auction specified by the first specifying code, causes said at least one processor to notify an alert to at least one of a bidder who makes a bid at the auction where the prompt decision price is set and a certain potential bidder who probably makes a bid at the auction.

17. The information processing apparatus according to claim 16, further comprising:
setting code that causes said at least one processor to set the reference price according to a bid unit based on the prompt decision price as a reference.

18. The information processing apparatus according to claim 16, further comprising:
first determining code that, when there are a plurality of auctions where the highest bid price in the other auction satisfies the predetermined condition for the reference price, causes said at least one processor to determine a priority of the alert notification with respect to auctions of at least a part of the plurality of auctions, based on a magnitude relationship of the prompt decision price set to the auction,
wherein the notifying code causes said at least one processor to notify an alert to the user of the auction in which the prompt decision price is set, according to the priority of the alert notification set by the first determining code.

19. The information processing apparatus according to claim 17, further comprising:
first determining code that, when there are a plurality of auctions where the highest bid price in the other auction satisfies the predetermined condition for the reference price, causes said at least one processor to determine a priority of the alert notification with respect to auctions of at least a part of the plurality of auctions, based on a magnitude relationship of the prompt decision price set to the auction,
wherein the notifying code causes said at least one processor to notify an alert to the user of the auction in which the prompt decision price is set, according to the priority of the alert notification set by the first determining code.

20. The information processing apparatus according to claim 16, further comprising:
acquiring code that, when there are a plurality of auctions where the highest bid price in the other auction satisfies the predetermined condition for the reference price, causes said at least one processor to acquire time zone information indicating usage time zone based on auction usage result by a bidder who makes a bid at each of the auctions; and
first determining code that causes said at least one processor to determine a priority of the alert notification with respect to at least a part of the plurality of auctions, based on usage time zone indicated by the time zone information acquired by the acquiring code, and a current time, and
wherein the notifying code causes said at least one processor to notify an alert to the user of the auction where the prompt decision price has been set, according to the priority of the alert notification determined by the first determining code.

21. The information processing apparatus according to claim 17, further comprising:
acquiring code that, when there are a plurality of auctions where the highest bid price in the other auction satisfies the predetermined condition for the reference price, causes said at least one processor to acquire time zone information indicating usage time zone based on auction usage result by a bidder who makes a bid at each of the auctions; and
first determining code that causes said at least one processor to determine a priority of the alert notification with respect to at least a part of the plurality of auctions, based on usage time zone indicated by the time zone information acquired by the acquiring code, and a current time, and
wherein the notifying code causes said at least one processor to notify an alert to the user of the auction where the prompt decision price has been set, according to the priority of the alert notification determined by the first determining code.

22. The information processing apparatus according to claim 16, further comprising:
first determining code that, when there are a plurality of auctions where the highest bid price in the other auction satisfies the predetermined condition for the reference price, causes said at least one processor to determine a priority of the alert notification with respect to the auctions browsed or registered in a watch list after the bid of the other auction by a bidder who makes a bid at the other auction,
wherein the notifying code causes said at least one processor to notify an alert to the user of the auction where the prompt decision price has been set, according to the priority of the alert notification determined by the first determining code.

23. The information processing apparatus according to claim 17, further comprising:
first determining code that, when there are a plurality of auctions where the highest bid price in the other auction satisfies the predetermined condition for the reference price, causes said at least one processor to determine a priority of the alert notification with respect to the auctions browsed or registered in a watch list after the bid of the other auction by a bidder who makes a bid at the other auction,
wherein the notifying code causes said at least one processor to notify an alert to the user of the auction where the prompt decision price has been set, according to the priority of the alert notification determined by the first determining code.

24. The information processing apparatus according to claim 16, further comprising:
acquiring code that, when there are a plurality of auctions where the highest bid price in the other auction satisfies the predetermined condition for the reference price, causes said at least one processor to acquire browsing time information indicating browsing time when at least one page among pages capable of browsing situations of the respective auctions was browsed after the bid of the other auction by a bidder who makes a bid at the other auction; and
first determining code that causes said at least one processor to determine a priority of the alert notification with respect to auctions of at least a part of the plurality of auctions, based on the browsing time indicated by the browsing time information acquired by the acquiring code,
wherein the notifying code causes said at least one processor to notify an alert to the user of the auction where the prompt decision price has been set, according to the priority of the alert notification determined by the first determining code.

25. The information processing apparatus according to claim 17, further comprising:
acquiring code that, when there are a plurality of auctions where the highest bid price in the other auction satisfies the predetermined condition for the reference price, causes said at least one processor to acquire browsing time information indicating browsing time when at least one page among pages capable of browsing situations of the respective auctions was browsed after the bid of the other auction by a bidder who makes a bid at the other auction; and
first determining code that causes said at least one processor to determine a priority of the alert notification with respect to auctions of at least a part of the plurality of auctions, based on the browsing time indicated by the browsing time information acquired by the acquiring code,
wherein the notifying code causes said at least one processor to notify an alert to the user of the auction where the prompt decision price has been set, according to the priority of the alert notification determined by the first determining code.

26. The information processing apparatus according to any one of claim 18, further comprising:
second determining code that causes said at least one processor to determine a range of the auction of which the priority of the alert notification is determined, based on the number of bidders who make a bid at the other auction.

27. The information processing apparatus according to any one of claim 18,
wherein the first determining code causes said at least one processor to determine the priority of the alert notification when it is determined that an item in the auction is not an item targeted for multiple purchases.

28. The information processing apparatus according to any one of claim 16,
wherein the notifying code causes said at least one processor to determine whether to notify the alert, based on a past bid history or purchase history of a bidder who makes a bid at the other auction.

29. The information processing apparatus according to any one of claim 17,
wherein the notifying code causes said at least one processor to determine whether to notify the alert, based on a past bid history or purchase history of a bidder who makes a bid at the other auction.

30. The information processing apparatus according to claim 28,
wherein the notifying code causes said at least one processor to determine to notify the alert when it is determined the bidder of the other auction is a user who made a bid at a past auction at a predetermined number of times or more, based on the past bid history of the bidder of the other auction.

31. The information processing apparatus according to claim 28,
wherein the notifying code causes said at least one processor to determine to notify the alert when it is determined that the bidder of the other auction is a user who made a successful bid for an item at the prompt decision price in a past auction, based on the past bid history of the bidder of the other auction.

32. The information processing apparatus according to claim 28,
wherein the notifying code causes said at least one processor to determine to notify the alert when it is determined that the bidder of the other auction is a user who purchased a plurality of the same items, based on a past purchase history of the bidder of the other auction.

33. The information processing apparatus according to any one of claim 16, further comprising:
third determining code that causes said at least one processor to determine a range of the user to which the alert is to be notified, based on the number of the auctions specified by the first specifying code.

34. The information processing apparatus according to any one of claim 17, further comprising:
third determining code that causes said at least one processor to determine a range of the user to which the alert is to be notified, based on the number of the auctions specified by the first specifying code.

35. An information processing method, which is performed by a computer,
the information processing method comprising:
specifying an auction in which a prompt decision price has been set and which has been unfinished, from a storage that stores information on an auction of an exhibited item with respect to each of a plurality of auctions;
specifying other auction in which at least one of an item name and an item code of the item exhibited in the auction is matched and which has been unfinished, from the storage, the item name and the item code being included in the information on the auction specified by the first specifying step; and
notifying, when a highest bid price in the other auction satisfies a predetermined condition for a reference price according to the prompt decision price set to the auction, an alert to at least one of a bidder who makes a bid at the auction where the prompt decision price is set and a certain potential bidder who probably makes a bid at the auction,
wherein at least one of the specifying the auction operation, specifying the other auction operation and the notifying operation is performed by at least one processor.
